(19) United States
(12) Patent Application Publication
(10) Pub. No.: US 2010/0119808 A1
(43) Pub. Date: May 13, 2010

(54) METHOD OF MAKING SUBSURFACE MARKS IN GLASS

(76) Inventors: Xinghua Li, Horseheads, NY (US); Correy Robert Ustanik, Painted Post, NY (US)

Correspondence Address: CORNING INCORPORATED, SP-TI-3-1, CORNING, NY, 14831, US

(21) Appl. No.: 12/267,754

(22) Filed: Nov. 10, 2008

(51) Int. Cl. B32B 17/00; B23K 26/08

(52) U.S. Cl. 428/312.6; 219/121.65; 219/121.66; 428/221

(57) ABSTRACT

In a method of making subsurface marks in glass, a beam of radiation is applied to the glass, the radiation having a wavelength that is ≦400 nm. The beam is applied using marking parameters of a marking device (e.g., a laser) effective to change a density and a resulting index of refraction of the glass to form subsurface marks having a size not greater than 50 μm without forming microcracks in the glass and without marking the surface of the glass. Another aspect is the glass having the subsurface marks disposed in a range of 20 to 200 microns below an outer surface of the glass.

### TECHNICAL FIELD

This disclosure is directed to making subsurface marks in glass, in particular, using a laser.

### TECHNICAL BACKGROUND

Types of markings that have been reported as being made by lasers are surface marking and bulk marking. Both types of marking use absorption of laser energy, either by linear or nonlinear processes, to bond, ablate, melt or break down material locally. A typical surface marking approach uses a visible or near infra-red laser to heat a layer of marking material to the surface of the workpiece so as to create bonding. The rest of the layer is later removed.

Marking inside a body such as glass has been widely used to generate artistic 3-D images. In this approach, the marks are typically laser-generated microcracks that are a few tens or hundreds of microns or larger. These microcracks are generated by micro-explosions of material heated instantaneously by laser pulses. To mark a large body the material is transparent or at least partially transparent at the laser wavelength. Typically, the laser marking is a result of a mixture of linear and nonlinear absorption of laser light by the materials. Linear absorption is described by the Beer Lambert law where the absorption coefficient is constant relative to light intensity whereas in the case of nonlinear absorption the absorption coefficient is dependant on light intensity.

A need exists for marking thin lines inside a glass body with good contrast. For example, these lines could be used as fiducials in glass compaction measurements. Ideally, fiducial lines are a few microns wide and lie several tens of microns beneath the glass surface. Furthermore, in most applications, the lines should be free of microcracks. Existing approaches generate lines on glass surfaces using a precision mechanical scribe. These lines tend to fade due to handling and rubbing with adjacent material.

In one method of making marks inside a glass body for identification and decorative purposes, nearly continuous lines were composed of individual points. The laser wavelength was maintained at a range at which the glass body had a transmittance of 60 to 95%. Microcracks were generated when the marks were formed, which is undesirable in applications such as fiducials. Therefore, a method of marking smooth, narrow marks, with crisp edges and high contrast, free of microcracks is still needed.

### SUMMARY

A first embodiment of this disclosure features a method of making subsurface marks in glass comprising applying a beam of radiation to the glass, the radiation having a wavelength that is ≦400 nm (1 nm=1×10⁻⁹ meter). The beam is applied using marking parameters of a marking device (e.g., a laser) effective to change a density and a resulting index of refraction of the glass to form subsurface marks having a size not greater than 50 μm (1 μm=1×10⁻⁶ meter) without forming microcracks in the glass and without marking the surface of the glass.

Regarding specific features of the first embodiment, the marks can be fiducials, which are known as marks used to measure changes to glass, such as those that occur by heating or cutting the glass. The marks can be formed at a location 20 to 200 microns below the surface of the glass, when measuring perpendicular to the glass surface. The glass can be a plate (e.g., of display glass) characterized by a strain point of at least 600° C. and a coefficient of thermal expansion ranging from 25 to 40×10⁻⁷/° C. The radiation wavelength can be ≦300 nm and in particular, 266 nm. The method can include forming a subsurface line composed of substantially circular or elliptical marks in a top view that spacially overlap each other by at least 90%. This line can have a width that is less than 10 microns and, in particular, a width of 2-5 microns.

When the beam is applied from a laser as the marking device, the method can include the steps of selecting values for marking depth, z, at which the beam can penetrate the glass without damaging the glass surface, and for the beam wavelength, λ, as laser marking parameters, and selecting glass having an absorption coefficient, α. Numerical aperture, NA, of the objective used in the laser, is calculated using the following relationship:

NA≧(10·(0.4·λ²)/z²·e^{-α·z})^{1/4}.

The calculated value of NA is used as another laser marking parameter.

In another variation of laser marking of this disclosure, the method comprises selecting values for numerical aperture, NA, of the objective used to focus the laser light, and for laser wavelength, λ, as the laser marking parameters, the glass having an absorption coefficient, α, at the laser wavelength. A marking depth, z, at which the beam can penetrate the glass without damaging the surface of the glass, is calculated using the following relationship:

z≧√(10.(0.4λ²)/(NA⁴.e^{-αz})).

The calculated value of z is used as another laser marking parameter.

In addition, along with either the calculated NA or z laser marking parameters and their corresponding selected laser marking parameters, the laser marking parameters can further include a laser repetition rate of at least 1 kHz, a laser pulse duration of not greater than 100 ns, a beam quality (M²) of less than 2, a fluence level at a focal spot of less than 20 J/cm², and the objective being antireflection coated at the laser wavelength, λ.

Another embodiment of this disclosure is glass having marks below an outer surface thereof The marks are disposed in a range of 20 to 200 microns below the surface without formation of microcracks in the glass and without marking the surface of the glass. The marks have a size that is not greater than 50 microns.

Referring to specific aspects of the second embodiment, the glass can be a plate characterized by a strain point of at least 600° C. and a coefficient of thermal expansion ranging from 25 to 40×10⁻⁷/° C. The marks can be observable using a microscope without polarizers. A subsurface line can be composed of substantially circular or elliptical marks in a top view that spacially overlap each other by at least 90%. The subsurface line has a width of not greater than 10 microns and, in particular, about 2-5 microns.

When this disclosure refers to marking below the outer surface of the glass at a certain depth, this is in regard to the center of a centroid of the laser mark. Therefore, referring, for example, to a mark that is at a depth of 50 microns below the surface of the glass having a marking centroid (or distance by which the mark travels along the z axis) of 6 microns, the 50 micron depth falls at the midpoint of the centroid so that 3 microns of the mark are both above and below the specified depth.

Fiducial marking of glass is discussed in published international patent application, WO 2006/116356 by Corning, Inc., which is incorporated herein by reference in its entirety. A discussion of linear and nonlinear absorption can be found in paper, Liu, X. et al., “Laser Ablation and Micromachining with Ultrashort Laser Pulses,” IEEE Journal of Quantum Electronics, Col. 33, No. 10, October 1977, which is incorporated herein by reference in its entirety.

Many additional features, advantages and a fuller understanding of this disclosure will be had from the accompanying drawings and the detailed description that follows. It should be understood that the above Summary is presented in broad terms while the following Detailed Description is presented more narrowly and presents embodiments that should not be construed as necessary limitations of the broad invention as defined in the claims.

### BRIEF DESCRIPTION OF THE DRAWINGS

FIG. 1 is a schematic view of a laser assembly used in this disclosure;

FIG. 2 shows transmittance of a glass plate as a function of wavelength in the ultraviolet range;

FIG. 3 is a photograph from an optical microscope showing marks from a laser on and inside a glass plate;

FIG. 4 is a photograph from an optical microscope showing a subsurface line made by a laser inside a glass plate; and

FIG. 5 is a photograph from an optical microscope showing a cross-section of a glass plate as in FIG. 3, in which the marks are each stepped down by 50 microns.

### DETAILED DESCRIPTION

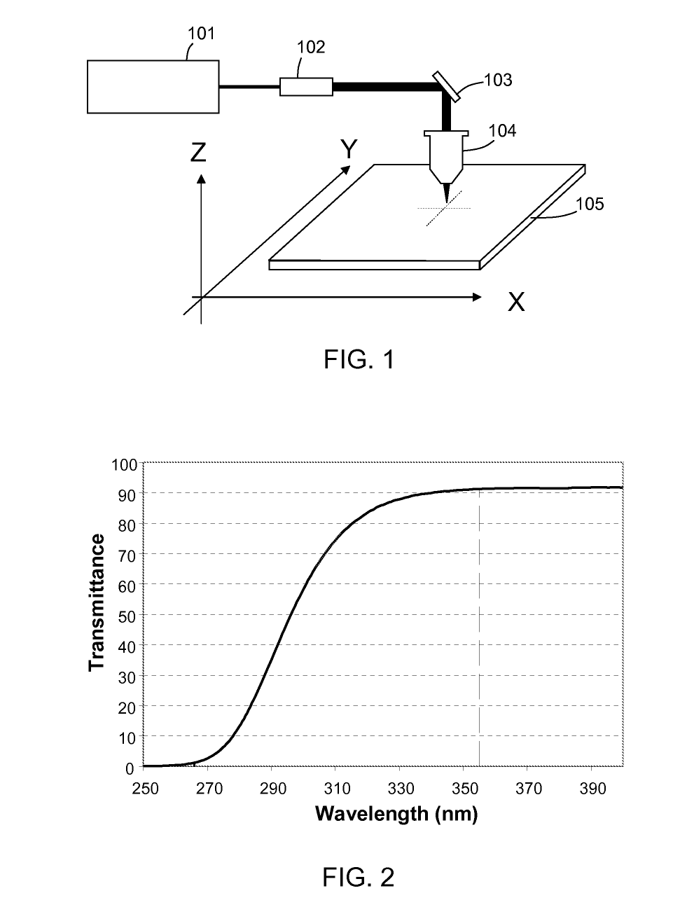

Referring to FIG. 1, an embodiment of this disclosure is illustrated wherein laser light from laser 101 (e.g., a 266 nm Nd:YVO₄ or neodymium vanadate DPSS laser) was expanded with a beam expander 102 (e.g., a 3× beam expander). A beam bender 103 or mirror was used to direct the laser light onto the entrance pupil of an optical objective 104 with a specific numerical aperture NA. The glass substrate 105 was placed on an XYZ motion table (not shown in the picture). The laser light was incident on the glass surface perpendicularly, which ensured that the subsurface marks were at a constant depth relative to the glass surface. The focal point of the objective 104 was adjusted onto the glass surface or inside the bulk glass though the z motion. Alternatively, the laser marking system comprised of lasers and optics 101-104 can be placed on a gantry, on which the laser marking system can be moved three-dimensionally relative to a stationary glass substrate.

When creating marks just beneath the surface of the glass (i.e., 200 microns or less), one consideration is that a surface damage threshold is typically several times lower than that of the bulk material. To avoid damaging the glass surface while bulk marking, the light intensity at the surface should be kept below the surface damage threshold, while keeping light intensity at the focal spot high enough to effect laser marking. The light intensity, I, is a function of both the instantaneous laser power, P, and beam size, A:

I=P/A. (1)

From the above equation it can be seen that lowering the laser instantaneous power and increasing the size of the beam at the glass surface both can reduce the intensity at the glass surface. At a given instantaneous laser power, the laser beam size at the glass surface should be large enough to avoid surface damage due to laser ablation, whereas the focal spot size should be small enough to effect laser marking. To accomplish this, short focal length lenses are used with a large numerical aperture to yield a highly divergent laser beam such that the laser beam size is considerably larger at the surface of the material.

Single element short focal length lenses typically suffer from optical aberrations, which increase with decreasing focal length. Lasers used in this disclosure have a fairly narrow spectral linewidth. Therefore, only monochromatic aberrations should be considered. Typical aberrations include spherical aberration, coma and astigmatism. Spherical aberration, for example, increases with decreasing focal length. A plano-convex single element lens, when used to focus a highly collimated laser light, is limited in its focal spot size by spherical aberration. The focal spot size due to spherical aberration is proportional to kD³/f², where D is input beam diameter at the lens, f is the focal length and k is an index of refraction function. With the increasing beam size, D, and decreasing focal length, f, spherical aberration and consequently spot size increases. Hence a spherical lens is unsuitable for use in marking thin lines just beneath a glass surface.

The optical objective is a multiple element lens that is well corrected with respect to different optical aberration. As such it is ideally suited for short focal length applications. When a laser beam with a Gaussian intensity distribution fills the optical aperture of the optical objective, the focal spot size (diameter) is at its smallest:

d=1.27(λ/NA). (2)

The corresponding depth of focus (DOF) is:

DOF=1.27(λ/NA²). (3)

The above equations (2) and (3) are for an idealized Gaussian beam with M² value of 1. For Gaussian beams with M² value of higher than 1, both the focal spot size and depth of focus scale proportionally.

The absorption of laser light as it travels inside an absorbing medium follows the Beer-Lambert law:

I(z)=Iₒe^{-αz}. (4)

In the above equation α is the absorption coefficient of the glass at the laser wavelength, and z is the distance light travels in the glass. The above equation shows that the light intensity decreases exponentially with increasing distance and absorption coefficient.

Consider a laser pulse with a pulse energy E. Let z be the distance between the glass surface and the focal point inside the glass where the subsurface marking is taking place. The fluence level at the incident surface, Fₛ, of the glass material is determined by

$${F}_{s} = \frac{E}{π {w}_{z}^{2}} ; \qquad ( 5 )$$

where w_{z} is the beam waist at the glass surface and z is the direction out of the page if x and y coordinates are in the page. The laser travels along the z axis. w_{z} is related to w₀ by

w_{z}=w₀√(1+(z/z_{R})²); (6)

where w₀ is the beam waist at the focus, and z_{R} is the Raleigh range which is half of the depth of focus given in equation (3).

Knowing the surface damage fluence and w_{z}, the maximum energy per pulse without damaging the glass surface can be determined.

Let

$${F}_{b} = \frac{E \cdot {e}^{- α \cdot z}}{π {w}_{0}^{2}} \qquad ( 7 )$$

be the fluence at the laser focus at a distance z below the glass surface. Assuming that the damage threshold of the glass surface is 10 times lower than that of the bulk, a successful subsurface marking without damaging the glass surface would require that

Fₛ [symbol] F_{b}/10. (8)

The above condition can be simplified into the following:

1/(1+(z/z_{R})²)<e^{-α.z}/10. (9)

In most of the cases considered here, subsurface marking is at a distance significantly longer than the Rayleigh range. Hence 1+(z/z_{R})²≈(z/z_{R})², and the further simplification of equation (9) yields:

NA>NAₘᵢₙ=(10·(0.4·λ²)/z²·e^{-α·z})^{1/4} (10)

The above equation directly correlates the NA of the multiple element lens (objective) with the absorption coefficient α, marking depth z and laser wavelength λ for subsurface marking. It provides first order estimation of required lens NA, knowing the absorption properties of the glass material, marking depth z and the available laser wavelengths. It is worth noting that refraction through the air-glass interface is not considered in the derivation.

Equation (10) was derived on the basis of linear absorption in which light absorption does not depend on laser intensity. As such it is only applicable to laser marking based on linear absorption. In principle a similar equation on nonlinear absorption could also be derived.

Equation (10) can be further transformed into the following,

z>zₘᵢₙ=√(10.(0.4λ²)/(NA⁴.e^{-αz})). (11)

Knowing the laser wavelength λ, material absorption α, and NA of the optical objective lens, the equation can be solved numerically to determine the minimum marking depth zₘᵢₙ at which subsurface marking can be carried out without damaging the glass surface.

In principle, marking can be carried out at any depth z so long as surface intensity I is kept below the damage threshold. In practice, however, because of optical absorption, the maximum marking depth z is limited by the beam diameter D at the focusing lens and the maximum laser pulse energy E.

Another consideration when laser marking with pulsed lasers is the pulse overlap. Making a line with pulsed lasers essentially involves spatially overlapping consecutive laser pulses. To mark lines with very good contrast and sharp edges, one needs to overlap the pulses to a high degree. The pulse overlap ratio, R, is defined as:

R=(D−d)/D, (12)

where D is laser focal spot diameter and d is spatial separation between adjacent pulses. Typically, the higher the pulse overlap, the smoother the lines are. The smaller the focal spot radius, the smaller the spatial separation it is required to keep the pulse overlap the same.

While not wanting to be bound by theory, the mechanism by which the glass is marked in this disclosure is believed to be due to the excitation energy from the laser causing localized glass density changes, which in turn change the local index of refraction without a substantial thermal expansion change and without formation of microcracks when viewed at a magnification of 20×. The absence of microcracks in the laser subsurface markings typically requires that the laser fluence at the laser focus is around the single pulse laser bulk damage threshold. The ordinary and extraordinary polarization states are changed uniformly so that the marks can be observed with a microscope without a polarizer.

The equations (10) and (11) can be used to give guidance in making laser marks in various glasses. The following nonlimiting examples will now be described which do not limit the invention as described in the claims. The examples were performed using a nanosecond 266 nm laser, in combination with an optical objective. A typical laser marking system is drawn in FIG. 1.

### EXAMPLE 1

Subsurface marking of BOROFLOAT® glass (Schott, Inc.) at a distance of roughly ˜150 um from the surface is desired. The laser of choice is a nanosecond 266 nm Nd:YVO₄ laser for its tight focal spot size. The absorption coefficient at the laser wavelength is roughly 8.8 cm⁻¹. The minimum NA required of the lens was calculated using the preceding equation to be 0.08.

### EXAMPLE 2

Subsurface marking of EAGLE XG glass (Corning) at a distance of roughly ˜150 um from the surface is desired. The laser of choice is a nanosecond 266 nm Nd:YVO₄ laser. The absorption coefficient at the laser wavelength is roughly 35 cm⁻¹. The minimum NA was calculated using the preceding equation to be 0.22.

### EXAMPLE 3

Fiducial laser marks were made just beneath the surface of Borofloat® glass. The transmittance of a 5 mm thick Borofloat® glass is shown in FIG. 2. The glass has little absorption above 400 nm. The UV absorption edge of the glass is below 360 nm. The transmittance of the materials at two wavelengths was determined. At the laser wavelength of 266 nm, the transmittance was about 1%, while at a comparative laser wavelength of 355 nm the transmittance was about 91%. The wavelength of the laser was selected relative to the transmittance of the glass to be substantially absorptive. The corresponding optical absorptive coefficients according to Beer's law calculated according to this disclosure are about 8.8 cm⁻¹ and 0.02 cm⁻¹, respectively. The 355 nm and 266 nm wavelengths are the third and fourth harmonics of an industrialized, high-repetition rate, moderate power Nd:YVO₄ laser. This laser is both rugged and compact and can be used industrially with relatively little maintenance.

The glass was marked using the laser light at 355 nm and 266 nm wavelengths. Marking at the 355 nm laser wavelength inside the glass using a single element spherical lens with a focus of 25 mm resulted in significant microcracks when viewed with a microscope having an objective lens at 10× power.

The glass was marked at the 266 nm wavelength using a frequency quadrupled Nd:YVO₄ laser (Spectra-Physics HIPPO), an XYZ table and a 10× UV objective with an NA of 0.3. The objective was made by OFR (model LMU-10X-266). Its effective focal length was 16 mm and the working distance was ˜6 mm. The laser had an M² value of about 1.5 and an output diameter of 2 mm. A 3× beam expander was used to expand the size of the beam to about 6 mm. The calculated spot diameter was roughly 3.4 μm, with a depth of focus of 23 μm. The laser was running with a repetition rate of 60 kHz. The laser power on the sample was 0.45 W. The scribing speed was 1 mm/s. The pulse special overlap ratio, based on the theoretical focal spot size, was 99.5%.

### EXAMPLE 4

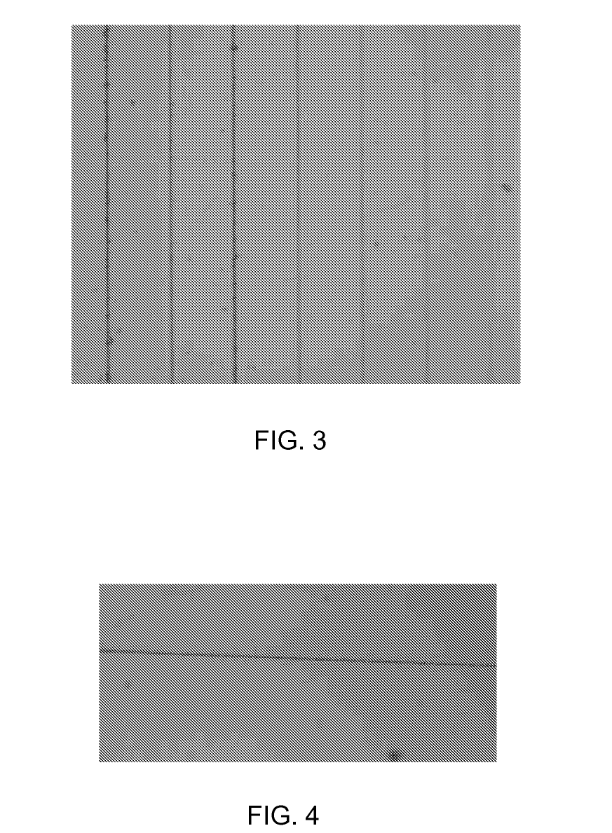

FIG. 3 is a photograph showing a series of laser marked lines using the laser settings of Example 3. From left to right, the lines were obtained by stepping down the laser focus into the glass body at a distance of 50 μm each time, starting at a location of +50 μm or 50 microns above the glass surface (i.e., the marks from left to right are located at +50, 0, −50, −100, −150 and −200, −250 microns, respectively, relative to the glass surface). Within each line the optical focus position was kept at the same height and the plate was moved in the z direction toward the laser. Under a low magnification of the optical microscope (5× magnification) the first 3 lines from the left were observed as laser ablated grooves on the glass surface. The rest of the lines were seen as marks inside the glass body. Under an optical microscope the lines marked in the “bulk” of the glass (i.e., subsurface lines only inside the glass) were smooth, with good contrast and no microcracks. It will be appreciated that using a higher NA lens the −50 mark will not form a groove on the surface of the glass, at the laser power and pulse energy settings used in Example 3.

### EXAMPLE 5

FIG. 4 is a photograph showing a line marked in the bulk under a machine vision system. The laser power was 0.70 W. The line had a consistent thickness of 5 μm and high contrast which is required for fiducial measurement markings at magnifications near 20×. An individual laser spot in the bulk has a diameter of 5 μm with a height of 5 μm. A minimum height profile is also necessary for fiducial measurement markings to provide invariance with respect to focal plane variation. The contrast mechanism is due to a localized index of refraction change from the density change from the laser energy pulse. The smooth edges of the laser marked lines are the direct result of high pulse overlapping ratio (>90%) and microcrack-free marking.

### EXAMPLE 6

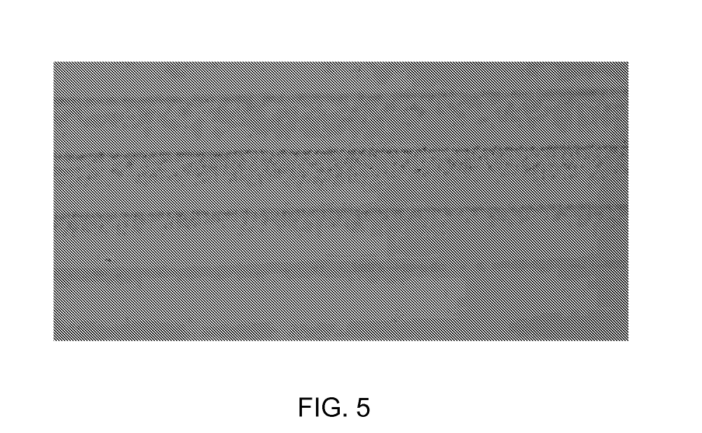

FIG. 5 is a photograph from an optical microscope of a cross-section of a glass body showing a series of laser marked lines. The vertical scale is the z-axis, or depth from the glass surface, which is located on the top of the picture. These lines were obtained by stepping down the laser focus into the glass body by a distance of 50 μm each time by moving the glass plate in the z direction toward the laser. The height of the main mark line was about 5 μm (in the z direction) with a corresponding field of contrast centers underneath to a depth of 25 μm. The laser power on the sample was 0.45 W.

To further reduce the width of the laser marked lines and its z-profiles inside the glass body, high NA objectives lenses were used. This further entailed slowing the marking speed to keep pulse overlap ratio constant.

To improve the centroid profile of the laser marked lines the lines should be free of microcracks and the laser should be stable over time. As shown in FIGS. 3-5, the 266 nm Nd:YVO₄ laser was suitable for such an application.

Referring to specific laser parameters suitable in this disclosure, the laser wavelength was 400 nm or less, more specifically 300 nm or less and in particular was 266 nm. The laser repetition rate was 1 kHz or higher, more specifically 30 kHz or higher, and in particular was 60 kHz or higher. The laser pulse duration was 100 ns or less, more specifically 20 ns or less. The Beam Quality (M²) was less than 2, more specifically less than 1.5. The Fluence Level at the focal spot was less than 20 J/cm², more specifically less than 10 J/cm². The laser objective was AR coated at the laser wavelength. The special overlap ratio was 95% or higher, more specifically 99% or higher, and in particular was 99.5% or higher. The polarization of the laser light is preferably in the direction of the marking lines for minimum width, whereas circularly polarized light would ensure similar width in the laser marked lines in any direction.

Many modifications and variations will be apparent to those of ordinary skill in the art in light of the foregoing disclosure. Therefore, it is to be understood that, within the scope of the appended claims, the invention can be practiced otherwise than has been specifically shown and described.

What is claimed is:

1. A method of making subsurface marks in glass comprising:
applying a beam of radiation to glass, said radiation having a wavelength that is ≦400 nm;
wherein said beam is applied using marking parameters of a marking device effective to change a density and a resulting index of refraction of the glass to form subsurface marks having a size not greater than 50 μm without forming microcracks in the glass and without marking the surface of the glass.

2. The method of claim 1, wherein said marks are fiducials.

3. The method of claim 1, wherein said marks are formed at a location 20 to 200 microns below the surface of the glass.

4. The method of claim 1, wherein said glass is a plate characterized by a strain point of at least 600° C. and a coefficient of thermal expansion ranging from 25 to 40×10⁻⁷/° C.

5. The method of claim 1, wherein said radiation wavelength is ≦300 nm.

6. The method of claim 5, wherein said radiation wavelength is 266 nm.

7. The method of claim 1, comprising forming a subsurface line composed of substantially circular or elliptical said marks in a top view that spacially overlap each other by at least 90%.

8. The method of claim 7, wherein a width of said line is less than 10 microns.

9. The method of claim 8, wherein said width of said line is about 2-5 microns.

10. The method of claim 1, wherein said beam is applied by a laser as said marking device, comprising:
selecting values for marking depth, z, at which the beam can penetrate the glass without damaging the glass surface, and for laser wavelength, λ, as said laser marking parameters, the glass having an absorption coefficient, a at wavelength λ;
calculating numerical aperture, NA, of an objective of the laser, using the following relationship:
NA≧(10·(0.4·λ²)/z²·e^{-α·z})^{1/4}; and
using said calculated value of NA as an additional said laser marking parameter.

11. The method of claim 1, wherein said beam is applied by a laser as said marking device, comprising:
selecting values for numerical aperture, NA, of an objective of the laser, and for laser wavelength, λ, as said laser marking parameters, the glass having an absorption coefficient, α;
calculating a marking depth, z, at which the beam can penetrate the glass without damaging the surface of the glass, using the following relationship:
z≧√(10.(0.4λ²)/(NA⁴.e^{-αz})); and
using said calculated value of z as an additional said laser marking parameter.

12. The method of claim 10, wherein said laser marking parameters further include a laser repetition rate of at least 1 kHz, a laser pulse duration of not greater than 100 ns, a beam quality (M²) of less than 2, a fluence level at a focal spot of less than 20 J/cm², and said objective that is antireflection coated at said laser wavelength, λ.

13. The method of claim 11, wherein said laser marking parameters further include a laser repetition rate of at least 1 kHz, a laser pulse duration of not greater than 100 ns, a beam quality (M²) of less than 2, a fluence level at a focal spot of less than 20 J/cm², and said objective that is antireflection coated at said laser wavelength, λ.

14. Glass having subsurface marks, wherein said marks are disposed in a range of 20 to 200 microns below an outer surface of the glass without formation of microcracks in said glass and without marking the surface of said glass, and said marks have a width that is not greater than 50 microns.

15. The glass of claim 14, wherein said glass is a plate characterized by a strain point of at least 600° C. and a coefficient of thermal expansion ranging from 25 to 40×10⁻⁷/° C.

16. The glass of claim 14, wherein said marks are observable using a microscope without polarizers.

17. The glass of claim 14, comprising a subsurface line composed of substantially circular or elliptical said marks in a top view that spacially overlap each other by at least 90%.

18. The glass of claim 17, wherein said subsurface line has a width of not greater than 10 microns.

19. The glass of claim 18, wherein said width of said line is about 2-5 microns.
